(19) United States
(12) Patent Application Publication
(10) Pub. No.: US 2023/0365111 A1
(43) Pub. Date: Nov. 16, 2023

(54) ELECTROHYDRAULIC BRAKE CONTROLLER FOR A MOTOR VEHICLE, AND BRAKE SYSTEM COMPRISING SUCH A BRAKE CONTROLLER

(71) Applicant: Continental Automotive Technologies GmbH, Hannover (DE)

(72) Inventors: Harald Biller, Eschborn (DE); Ulrich Linden, Frankfurt am Main (DE); Martin Baechle, Kelkheim (DE); Thorsten Ullrich, Gernsheim (DE); Marius-Vasilica Adam, Iasi (RO)

(73) Assignee: Continental Automotive Technologies GmbH, Hannover (DE)

(21) Appl. No.: 18/246,674

(22) PCT Filed: Sep. 10, 2021
(86) PCT No.: PCT/DE2021/200121

§ 371 Date: Mar. 25, 2023

(30) Foreign Application Priority Data
Sep. 28, 2020 (EP) 20465564.1
Nov. 6, 2020 (DE) 10 2020 213 997.0

(51) Int. Cl. B60T 13/68; B60T 13/74

(52) U.S. Cl. CPC B60T 13/686; B60T 13/745; B60T 2270/402

(57) ABSTRACT

An electrohydraulic brake controller comprises at least two first and two second output ports for at least four wheel brakes, s hydraulic pressure source, a first electronic open-loop and closed-loop control unit, a second electronic open-loop and closed-loop control unit, an inlet valve for each first and second output port, and an outlet valve for each first and second output port. A pressure chamber is connected via a first pressure activation valve to a brake line section to which the at least four inlet valves are connected. If the first electronic control unit fails, an electromechanical actuator is activated by the second electronic control unit and builds up pressure to actuate the wheel brakes. If the second electronic control unit fails, the electromechanical actuator is activated by the first control unit and builds up pressure to actuate the wheel brakes.

### CROSS-REFERENCE TO RELATED APPLICATIONS

The present application is a National Stage Application under 35 U.S.C. § 371 of International Patent Application No. PCT/DE2021/200121 filed on Sep. 12, 2021 and claims priority from German Patent Application No. 10 2020 213 997.0, filed on Nov. 6, 2020, in the German Patent and Trademark Office, and European Patent Application No. 20465564.1 filed on Sep. 28, 2020, in the European Patent Office, the disclosures of which are herein incorporated by reference in their entireties.

### TECHNICAL FIELD

The invention relates to an electrohydraulic brake controller and to a brake system comprising such a brake controller.

### BACKGROUND

DE 10 2017 216 617A1 discloses a brake controller comprising four output ports for four hydraulically actuable wheel brakes, a first electronic open-loop and closed-loop control unit, a second electronic open-loop and closed-loop control unit, a pressure medium reservoir, and an inlet and outlet valve for each output port, the respective output port being connected via the outlet valve to the pressure medium reservoir. In order to be suitable for highly automated driving and to be able to dispense with a mechanical and/or hydraulic fall-back level, in which the driver can actuate the wheel brakes using muscle power, the brake controller comprises a first and a second electrically activatable hydraulic pressure source, the first pressure source being actuated by the first electronic open-loop and closed-loop control unit and the second pressure source being actuated by the second electronic open-loop and closed-loop control unit. Furthermore, an electrically actuable circuit separation device is provided, by which the brake system is separated in the de-energized state into a first brake circuit with the first pressure source and two of the wheel brakes and a second brake circuit with the second pressure source and the other two wheel brakes.

It is an object to provide an alternative electrohydraulic brake controller, which is suitable for highly automated driving, and a brake system for a motor vehicle, which can dispense with a mechanical and/or hydraulic fall-back level and nevertheless has a high level of availability and thus provides sufficient safety for highly automated driving or an autopilot function.

A brake controller comprises an electrically activatable hydraulic pressure source, an inlet and outlet valve for each of the at least four wheel brakes, a first electronic open-loop and closed-loop control unit and a second electronic open-loop and closed-loop control unit. The pressure source is formed by a cylinder-piston arrangement with a pressure chamber, the piston of which can be pushed back and forth by an electromechanical actuator. The pressure chamber is connected via a first electrically actuable pressure activation valve to a brake line section to which the at least four inlet valves are connected. Furthermore, electrical and/or electronic means are provided which are configured such that, if the first electronic open-loop and closed-loop control unit fails, the electromechanical actuator is activated by the second electronic open-loop and closed-loop control unit and builds up pressure to actuate the wheel brakes, and that, if the second electronic open-loop and closed-loop control unit fails, the electromechanical actuator is activated by the first electronic open-loop and closed-loop control unit and builds up pressure to actuate the wheel brakes.

The brake line section connects the output port of the first pressure activation valve to each of the input ports of the (at least four) inlet valves. The brake line section may connect the at least four inlet valves, i.e. the inlet valves of the first output ports and the second output ports, directly to one another. In this sense, the brake controller or its provision of pressure by the hydraulic pressure source is preferably designed as a single circuit.

For example, no valve, e.g. no valve which is actuable electrically or hydraulically and no nonreturn valve, is arranged in the brake line section. The brake line section is preferably delimited on the wheel brake side by the (at least four) inlet valves and on the pressure source side by the first pressure activation valve or, if a second pressure activation valve is present, by the first and second pressure activation valves. If the brake line section is connected to the pressure medium reservoir via a separation valve, the brake line section is delimited on the pressure medium reservoir side by the separation valve.

If one of the electronic open-loop and closed-loop control units fails, the electromechanical actuator is thus activated by the other electronic open-loop and closed-loop control unit and pressure is built up to actuate the wheel brakes in the brake-by-wire operating mode for service braking.

The electromechanical actuator is operated with at least part of its power to build up pressure to actuate the wheel brakes by means of the one functional electronic open-loop and closed-loop control unit.

According to an embodiment of the brake controller, the electrical and/or electronic means comprise the electromechanical actuator comprising a double-wound electric motor with a first motor winding and a second motor winding, the first motor winding being activated exclusively by the first electronic open-loop and closed-loop control unit and the second motor winding being activated exclusively by the second electronic open-loop and closed-loop control unit. A second electrically activatable hydraulic pressure source can thus be dispensed with. Even following a single electrical or electronic fault, it is possible to brake all the wheel brakes.

The electrohydraulic brake controller comprises at least two first output ports and two second output ports for at least four hydraulically actuable wheel brakes, an electrically activatable hydraulic pressure source, a first electronic open-loop and closed-loop control unit, a second electronic open-loop and closed-loop control unit, a pressure medium reservoir, for example under atmospheric pressure, an inlet valve for each first and second output port, and an outlet valve for each first and second output port, via which the respective output port is connected to the pressure medium reservoir. The pressure source is formed by a cylinder-piston arrangement with a pressure chamber and a piston, wherein the piston can be pushed back and forth by an electromechanical actuator. The pressure chamber is connected via a first electrically actuable pressure activation valve to a brake line section to which the inlet valves are connected, and wherein the electromechanical actuator comprises a double-wound electric motor having a first motor winding and a second motor winding, wherein the first motor winding is activated by the first electronic open-loop and closed-loop control unit and the second motor winding is activated by the second electronic open-loop and closed-loop control unit. The double-wound electric motor with the activation of the first motor winding by the first electronic open-loop and closed-loop control unit and the activation of the second motor winding by the second electronic open-loop and closed-loop control unit represents electrical and/or electronic means that are configured such that, in the event of failure of the first electronic open-loop and closed-loop control unit, the electromechanical actuator is activated by means of the second electronic open-loop and closed-loop control unit and builds up pressure to actuate the wheel brakes, and that, in the event of failure of the second electronic open-loop and closed-loop control unit, the electromechanical actuator is activated by means of the first electronic open-loop and closed-loop control unit and builds up pressure to actuate the wheel brakes.

The double-wound electric motor thus comprises a first motor winding and a second motor winding, each of the two motor windings being activated by one of the two electronic open-loop and closed-loop control units. In a certain sense, the electric motor is configured in two parts. If both motor windings are activated by both electronic open-loop and closed-loop control units, the electric motor delivers full power. If only one of the two electronic open-loop and closed-loop control units activates the corresponding motor winding, the pressure source can build up pressure, albeit at a reduced level and with reduced dynamics, with all the at least four wheel brakes being subjected to said pressure. The vehicle can nevertheless be braked and brought to a standstill.

The first electronic open-loop and closed-loop control unit comprises a first output stage for providing phase voltages and a first driver stage for activating the first output stage, with the first output stage being connected to the first motor winding, and the second electronic open-loop and closed-loop control unit comprises a second output stage for providing phase voltages and a second driver stage for activating the second output stage, the second output stage being connected to the second motor winding.

The first and the second electronic open-loop and closed-loop control units each comprise a motor processor.

The first electronic open-loop and closed-loop control unit is supplied by a first electrical energy supply and the second electronic open-loop and closed-loop control unit is supplied by a second electrical energy supply that is independent of the first energy supply.

According to another embodiment of the brake controller, the electrical and/or electronic means comprise the electromechanical actuator comprising a single-wound electric motor with a motor winding, and the first and the second electronic open-loop and closed-loop control unit each having an output stage for providing phase voltages and a driver stage for activating the output stage, the output stage of the first electronic open-loop and closed-loop control unit and the output stage of the second electronic open-loop and closed-loop control unit being connected to the motor winding of a single-wound electric motor and being designed in such a way that their outputs, should the associated electronic open-loop and closed-loop control unit fail—have high impedance. The motor winding of the electric motor can thus be activated by either of the two electronic open-loop and closed-loop control units.

The first and the second electronic open-loop and closed-loop control unit each comprise a motor processor.

The first electronic open-loop and closed-loop control unit may supplied by a first electrical energy supply and the second electronic open-loop and closed-loop control unit is supplied by a second electrical energy supply which is independent of the first energy supply.

According to a further embodiment of the brake controller, the electrical and/or electronic means comprise the electromechanical actuator comprising a single-wound electric motor with a motor winding, the first and the second electronic open-loop and closed-loop control unit each comprising a motor processor, a third electronic open-loop and closed-loop control unit being provided which comprises a first and a second output stage for providing phase voltages, a first and a second driver stage, and relays, wherein the relays are designed in such a manner that each motor processor can transmit its output signals to each of the two driver stages and each driver stage can activate each output stage, and the first and the second output stage being connected to the motor winding of the single-wound electric motor.

The first electronic open-loop and closed-loop control unit is supplied by a first electrical energy supply, the second electronic open-loop and closed-loop control unit is supplied by a second electrical energy supply which is independent of the first energy supply, and the third electronic open-loop and closed-loop control unit can be supplied in a manner which can be switched from the first or the second energy supply.

According to a further embodiment of the brake controller, the electrical and/or electronic means comprise the electromechanical actuator comprising a first and a second electric motor, each with a motor winding, the first and the second electric motor being able to push the piston of the pressure source alone or together back and forth, the first electronic open-loop and closed-loop control unit comprising a first output stage for providing phase voltages and a first driver stage for activating the first output stage, the first output stage being connected to the motor winding of the first electric motor, and the second electronic open-loop and closed-loop control unit comprising a second output stage for providing phase voltages and a second driver stage for activating the second output stage, the second output stage being connected to the motor winding of the second electric motor.

The first and the second electronic open-loop and closed-loop control unit each comprise a motor processor.

The first electronic open-loop and closed-loop control unit is supplied by a first electrical energy supply and the second electronic open-loop and closed-loop control unit is supplied by a second electrical energy supply which is independent of the first energy supply.

The pressure activation valve and at least the inlet and outlet valves for two of the wheel brakes may be actuated by the first electronic open-loop and closed-loop control unit. The first pressure activation valve and at least the inlet and outlet valves of the first output ports may be actuated by the first electronic open-loop and closed-loop control unit.

The first electronic open-loop and closed-loop control unit and the second electronic open-loop and closed-loop control unit are configured separately and are connected to one another via redundant signal lines.

The first electronic open-loop and closed-loop control unit and the second electronic open-loop and closed-loop control unit are electrically independent of one another in the sense that failure of the first electronic open-loop and closed-loop control unit does not cause failure of the second electronic open-loop and closed-loop control unit, and vice versa.

The pressure source is designed as a single circuit. The pressure source comprises only one pressure chamber.

The pressure chamber is connected to the brake line section, to which the inlet valves are connected, via a first electrically actuable pressure activation valve. Each of the inlet valves is connected to the first pressure activation valve without the interposition of a further electrically actuable valve. Each of the inlet valves is connected directly, i.e. without the interposition of a valve, to the first pressure activation valve.

In other words, no electrically actuable valve, further in one embodiment no valve, is arranged in the brake line section between the first electrically actuable pressure activation valve and each of the inlet valves.

Each valve of the brake controller, e.g. the inlet valves and/or the outlet valves and/or the pressure activation valve(s) and/or the separation valve(s), is actuated solely or exclusively by one of the two electronic open-loop and closed-loop control units.

The first motor winding is activated exclusively by the first electronic open-loop and closed-loop control unit and the second motor winding is activated exclusively by the second electronic open-loop and closed-loop control unit.

According to a further development, parking brakes which are actuable electrically are provided on the wheels assigned to the wheel brakes of the second output ports.

The electrically actuable parking brakes are actuated by the first electronic open-loop and closed-loop control unit in order to be able to brake the corresponding wheel brakes. The rear wheels, may be actuated purely electrically and dynamically if the second open-loop and closed-loop control unit fails.

Each of the inlet valves is activatable analogously and is normally open. A nonreturn valve closing in the direction of the associated output port is connected in parallel with respect to each inlet valve.

Each of the outlet valves may be normally closed. The outlet valves are designed as switching valves.

The first pressure activation valve and at least the inlet and outlet valves of the first output ports may be only or exclusively actuated by the first electronic open-loop and closed-loop control unit.

The first output ports are assigned to the wheel brakes of one axle of the vehicle and the second output ports are assigned to the wheel brakes of the other axle of the vehicle. The first output ports are assigned to the wheel brakes of the front axle and the second output ports are assigned to the wheel brakes of the rear axle of the vehicle.

A first pressure sensor is connected to the brake line section for pressure control by the first open-loop and closed-loop control unit, the signals from the first pressure sensor being fed to the first electronic open-loop and closed-loop control unit and evaluated by the latter.

A second pressure sensor is connected to the brake line section, the signals from the second pressure sensor being fed to the second electronic open-loop and closed-loop control unit and evaluated by the latter. Precise pressure control is thus also possible by the second electronic open-loop and closed-loop control unit.

The first electrically actuable pressure activation valve is normally closed and the pressure chamber is additionally connected to the brake line section via a second electrically actuable pressure activation valve which is normally closed and which is actuated, in particular exclusively, by the second electronic open-loop and closed-loop control unit. The pressure chamber is thus hydraulically connected to the brake line section via a parallel connection of the first and second, normally closed, pressure activation valves. Each of the two open-loop and closed-loop control units can connect the pressure chamber to the brake line section, and vice versa.

Alternatively, the first electrically actuable pressure activation valve is normally open. The first pressure activation valve may be exclusively, actuated by the first electronic open-loop and closed-loop control unit. In order to increase the flow, the pressure chamber is connected to the brake line section via a nonreturn valve opening in the direction of the inlet valves. In other words, a nonreturn valve opening in the direction of the inlet valves or the output ports is connected in parallel with respect to the first electrically actuable pressure activation valve. The pressure chamber is thus hydraulically connected to the brake line section via a parallel connection of the first, normally open, pressure activation valve and nonreturn valve. Only the first open-loop and closed-loop control unit can connect the brake line section to the pressure chamber or separate same from the pressure chamber.

The brake controller preferably does not comprise any further hydraulic pressure source, e.g. no further electrically activatable hydraulic pressure source.

The inlet and outlet valves of the second output ports are, e.g. exclusively, actuated by the first electronic open-loop and closed-loop control unit, with the brake line section being connected to the pressure medium reservoir via a separation valve device having at least one first electrically actuable separation valve, the first separation valve being actuated, e.g. exclusively, by the second electronic open-loop and closed-loop control unit.

The first separation valve may be normally closed and the separation valve device comprises only the first electrically actuable separation valve. In this way, pressure equalization outside braking operations is possible with just one valve. One of the outlet valves of the second output ports is connected in parallel with a nonreturn valve opening in the direction of the output port, in order to avoid a negative pressure in the system in the de-energized state.

Alternatively, the separation valve device preferably comprises the first electrically actuable separation valve and a second electrically actuable separation valve connected upstream or downstream thereof, the second separation valve being actuated by the first electronic open-loop and closed-loop control unit. The first and the second separation valve are normally open.

The inlet and outlet valves of the second output ports are actuated, e.g. exclusively, by the second electronic open-loop and closed-loop control unit. There is no hydraulic connection between the brake line section and the pressure medium reservoir via a separation valve device. If one of the open-loop and closed-loop control units fails, wheel-specific pressure modulation on two of the wheel brakes is still possible. A second pressure sensor is therefore connected to the brake line section, with the signals from the second pressure sensor being fed to the second electronic open-loop and closed-loop control unit and evaluated by the latter. One of the outlet valves of the second output ports is connected in parallel with a nonreturn valve opening in the direction of the output port, in order to avoid a negative pressure in the system in the de-energized state.

According to a further development, the outlet valves of the second output ports are normally open. The outlet valves of the second output ports are (additionally) designed to be activatable analogously. The outlet valves of the first output ports are designed as switching valves and are normally open. There is no hydraulic connection between the brake line section and the pressure medium reservoir via a separation valve device.

According to an embodiment of the development, the inlet valves of the second output ports are actuated, e.g. exclusively, by the first electronic open-loop and closed-loop control unit and the outlet valves of the second output ports are actuated, e.g. exclusively, by the second electronic open-loop and closed-loop control unit. Electrically actuable parking brakes, which are actuated, e.g. exclusively, by the first electronic open-loop and closed-loop control unit, are provided on the wheels which are assigned to the second output ports.

According to another embodiment of the development, for the one second output port the inlet valve is actuated, e.g. exclusively, by the first electronic open-loop and closed-loop control unit and the outlet valve is actuated, e.g. exclusively, by the second electronic open-loop and closed-loop control unit, wherein, for the other second output port, the inlet valve is actuated, e.g. exclusively, by the second electronic open-loop and closed-loop control unit and the outlet valve is actuated, e.g. exclusively, by the first electronic open-loop and closed-loop control unit. A first electrically actuable parking brake, which is actuated by the first electronic open-loop and closed-loop control unit, is provided on the wheel which is assigned to the one second output port, while a second electrically actuable parking brake, which is actuated by the second electronic open-loop and closed-loop control unit, is provided on the wheel which is assigned to the other second output port. After failure of an open-loop and closed-loop control unit, the two wheels of the first output ports and one of the wheels of the second output ports can thus be braked hydraulically. The other wheel of the second output ports is braked by the parking brake.

According to an embodiment of the brake controller, the pressure chamber (30) is connected to the brake line section (60) via only the one first electrically actuable pressure activation valve (19), the first electrically actuable pressure activation valve (19) being normally open and a nonreturn valve (20) opening in the direction of the inlet valves (6a-6d) being connected in parallel with respect to the first electrically actuable pressure activation valve (19).

The at least four inlet valves (6a-6d) are normally open and are actuated by the first electronic open-loop and closed-loop control unit (A), with the outlet valves (7a, 7b) of the first output ports (4a, 4b) being normally closed and being actuated by the first electronic open-loop and closed-loop control unit (A), and wherein the outlet valves (7c, 7d) of the second output ports (4c, 4d) are normally open, with at least one of the outlet valves (7c; 7c, 7d) of the second output ports (4c; 4c, 4d) (or else both outlet valves (7c; 7c, 7d)) being actuated by the second electronic open-loop and closed-loop control unit (B).

The electrically actuable parking brake (50a) or electrically actuable parking brakes (50a, 50b) is or are actuated by the first electronic open-loop and closed-loop control unit (A), which is assigned to that second output port (4c) or those second output ports (4c, 4d), the outlet valve(s) (7c, 7d) of which is/are actuated by the second electronic open-loop and closed-loop control unit (B). The other outlet valve (7d) of the second output ports (4d) can be actuated by the first electronic open-loop and closed-loop control unit (A), the electrically actuable parking brake (50b), which is assigned to that second output port (4d), the outlet valve (7d) of which is actuated by the first electronic open-loop and closed-loop control unit (A), being actuated by the second electronic open-loop and closed-loop control unit (B).

The pressure chamber of the pressure source may be connected to the pressure medium reservoir via a hydraulic connection in which a nonreturn valve opening in the direction of the pressure chamber is arranged.

The pressure source does not comprise a breather hole or a connection to the pressure medium reservoir via a breather hole.

A brake system comprises an actuation unit for a vehicle driver and an electrohydraulic brake controller as described herein. The actuation unit is connected to the brake controller by transmitting a driver's request signal. There is no mechanical-hydraulic connection from the actuation unit to the brake controller (no hydraulic fall-back level).

### BRIEF DESCRIPTION OF THE DRAWINGS

Further embodiments will emerge from the dependent claims and the following description with reference to figures, in which, schematically:

FIG. 1 shows a first exemplary embodiment of a brake controller,

FIG. 2 shows a second exemplary embodiment of a brake controller,

FIG. 3 shows a third exemplary embodiment of a brake controller,

FIG. 4 shows a fourth exemplary embodiment of a brake controller,

FIG. 5 shows a fifth exemplary embodiment of a brake controller, and

FIG. 6 shows a sixth exemplary embodiment of a brake controller.

### DETAILED DESCRIPTION

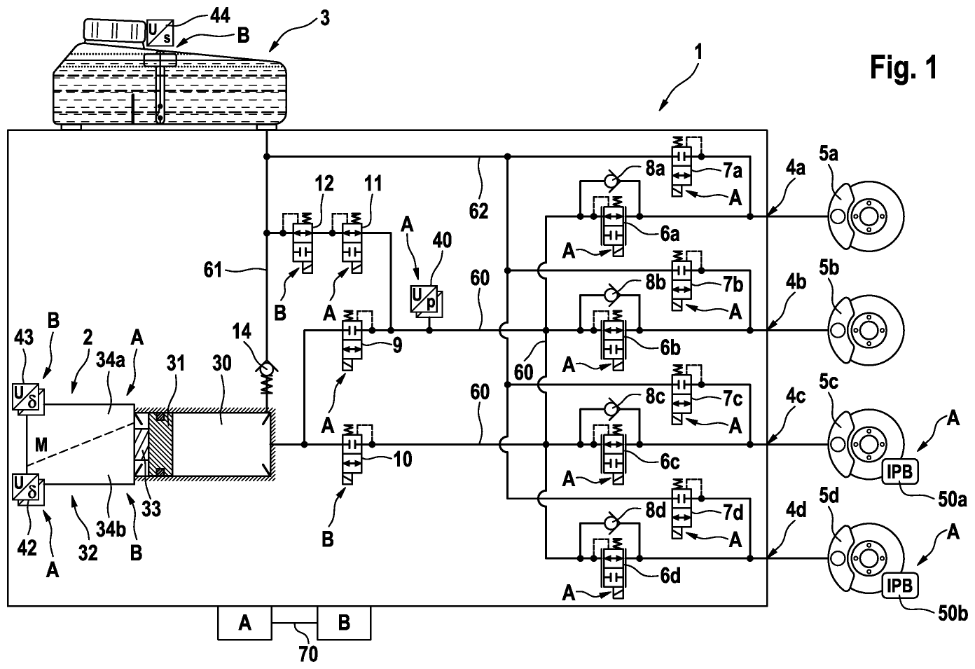

FIG. 1 schematically illustrates a first exemplary embodiment of a brake controller 1 for a motor vehicle having four hydraulically actuable wheel brakes 5a-5d.

The brake controller 1 comprises a valve block (hydraulic open-loop and closed-loop control unit), not denoted specifically, with an output port 4a-4d for each wheel brake 5a-5d. A pressure medium reservoir 3 which is under atmospheric pressure is arranged on the valve block. According to the example, the (first) output ports 4a, 4b are assigned to the wheel brakes 5a, 5b of the front axle (front) and the (second) output ports 4c, 4d are assigned to the wheel brakes 5c, 5d of the rear axle (rear).

The fill level of the pressure medium reservoir 3 is measured by a fill level sensor 44.

Each output port 4a-4d is assigned an inlet valve 6a-6d and an outlet valve 7a-7d. A nonreturn valve 8a-8d closing in the direction of the associated output port 4a-4d is connected in parallel with respect to each inlet valve 6a-6d. The respective output port 4a-4d is connected to the pressure medium reservoir 3 via the outlet valve 7a-7d. The inlet valves 6a-6d are designed, for example, to be normally open and activatable analogously, the outlet valves 7a-7d are designed as normally closed switching valves.

For example, the outlet valves 7a-7d are connected to the pressure medium reservoir 3 via a common return line 62.

An electrically activatable hydraulic pressure source 2 is provided which is formed by a cylinder-piston arrangement with a pressure chamber 30, the piston 31 of which is actuable by an electromechanical actuator with a schematically indicated electric motor 32 and a schematically illustrated rotational translation gearing 33. For example, the pressure source 2 is designed as a single-circuit electrohydraulic linear actuator (LAC) with only one pressure chamber 30. The piston 31 can be advanced by means of the electromechanical actuator to build up pressure (brake actuation direction) and pushed back or pulled back to reduce pressure. The electric motor here is designed as a double-wound electric motor 32 with a first motor winding 34a and a second motor winding 34b. If both motor windings 34a, 34b are activated, the electric motor 32 supplies full power. If only one of the two motor windings 34a, 34b is activated, although the power of the electric motor 32 is reduced, pressure can still be built up by means of the pressure source 2, albeit at a reduced level and with reduced dynamics.

For example, the brake controller 1 comprises only the one hydraulic pressure source 2.

At least one first motor angle sensor 43 is provided for activating the pressure source 2. For example, a second motor angle sensor 42 is additionally provided.

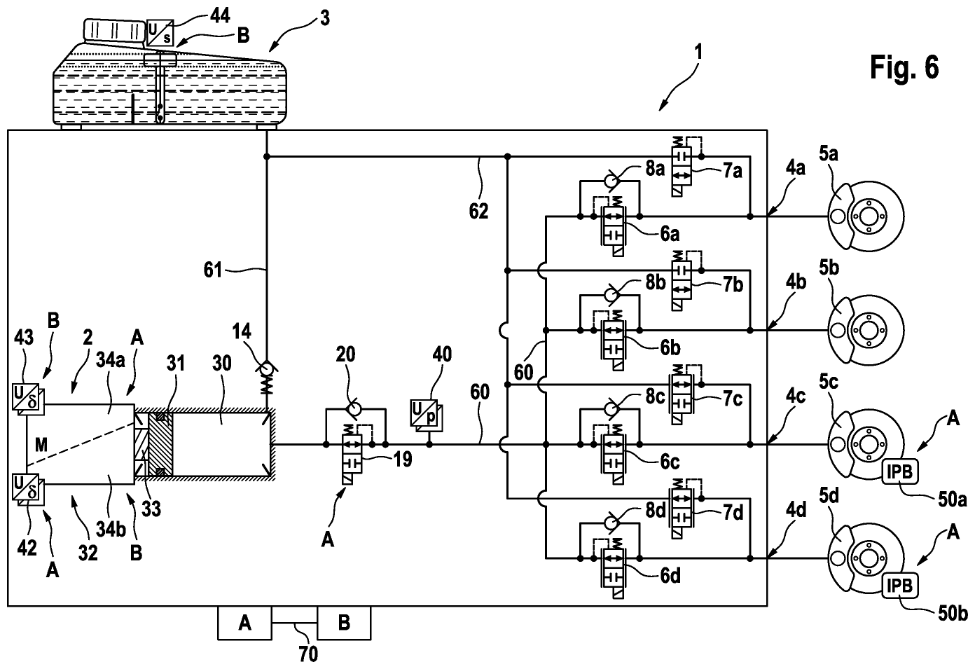

The pressure chamber 30 is hydraulically connected to a brake line section 60 via a (first) electrically actuable pressure activation valve 9. The inlet valves 6a-6d are connected to the brake line section 60. The brake line section 60 thus connects the output port of the first pressure activation valve 9 (or 19 in FIG. 6) to each of the input ports of the inlet valves 6a-6d. The pressure chamber 30 is connected to the input port of the first pressure activation valve 9 (or 19 in FIG. 6). The output port of each inlet valve 6a-6d is connected to the assigned output port 4a-4d of the brake controller 1 for the wheel brakes 5a-5d.

For example, the pressure chamber 30 is connected to the brake line section 60 via a further electrically actuable (second) pressure activation valve 10. In other words, the pressure chamber 30 is hydraulically connected to the brake line section 60 via two pressure activation valves 9, 10 connected in parallel with respect to one another. The pressure activation valves 9, 10 are normally closed.

The function of the pressure activation valves 9, 10 is to enable the linear actuator 2 to replenish pressure medium after a volume-consuming pressure modulation (i.e. with the discharge of pressure medium via the outlet valves into the pressure medium reservoir 3).

According to an exemplary embodiment, not illustrated, the pressure chamber 30 is connected to the brake line section 60 via a (single) electrically actuable, normally open pressure activation valve with a nonreturn valve connected in parallel and opening in the direction of the inlet valves 6a-6d (correspondingly as shown in FIG. 6: first, normally open pressure activation valve 19 with nonreturn valve 20 connected in parallel).

In each case only precisely one valve, namely one of the pressure activation valves 9 or 10 (exemplary embodiment of FIG. 1) or one of the valves 19 or 20 (exemplary embodiment not illustrated), is arranged in the hydraulic connections from the pressure chamber 30 to each of the inlet valves 6a-6d. Correspondingly, no electrically actuable valve, in particular no valve, is arranged in the brake line section 60 between the first pressure activation valve (9 or 19) and each of the inlet valves 6a-6d. The same applies to the second pressure activation valve 10 and each of the inlet valves 6a-6d. That is to say, the pressure activation valve(s) 9, 10 are directly connected to all the inlet valves 6a-6d without the interconnection of a valve.

A (first) pressure sensor 40 which can be used to determine the pressure generated by the pressure source 2 is connected to the brake line section 60.

To draw pressure medium into the pressure source 2, the pressure chamber 30 of the pressure source 2 is connected to the pressure medium reservoir 3 via a hydraulic connection 61, in which a nonreturn valve 14 opening in the direction of the pressure chamber 30 is arranged.

For example, the return line 62 and the hydraulic connection 61 are formed via an at least partially common line section.

The brake line section 60 is connected, for example, to the pressure medium reservoir 3 via a separation valve device consisting of two electrically actuable separation valves 11, 12 connected in series. The separation valves 11, 12 connected in series are arranged, for example, between the brake line section 60 and the hydraulic (replenishment) connection 61. The two normally open separation valves 11, 12 serve for the function of pressure equalization outside braking operations.

Electric parking brakes 50a, 50b are provided on the wheels of one of the axles, for example on the rear axle (rear). The electric parking brakes 50a, 50b are activated or actuated by the brake controller 1. The wheel brakes of the rear axle are designed as combination brake calipers with a hydraulic wheel brake 5c, 5d and an integrated, electrically actuable parking brake (IPB).

The brake controller 1 furthermore comprises a first electronic open-loop and closed-loop control unit A and a separate, second electronic open-loop and closed-loop control unit B for activating the electrically actuable components of the brake controller 1 and parking brakes 50a, 50b. The open-loop and closed-loop control units A and B are connected to one another via redundant signal lines 70.

The arrows A or B on the electrical or electrically actuable components, such as valves and sensors, indicate the assignment to the electronic open-loop and closed-loop control unit A or B.

The electric motor 32 of the pressure source 2 is activated by the first and the second electronic open-loop and closed-loop control unit in the sense that the first motor winding 34a is activated (only) by the first electronic open-loop and closed-loop control unit A (marked by an arrow with A) and the second motor winding 34b is activated (only) by the second electronic open-loop and closed-loop control unit B (marked by an arrow with B).

The valves 6, 7, 9-12 and sensors 40, 42, 43, 44 of the brake controller 1 are each assigned to only one of the electronic open-loop and closed-loop control units, i.e. are activated exclusively by the electronic open-loop and closed-loop control unit A or exclusively by the electronic open-loop and closed-loop control unit B. This avoids complex, doubly activatable valves/valve coils.

According to the first exemplary embodiment, the inlet and outlet valves 6a-6d, 7a-7d, the (first) pressure activation valve 9 and the separation valve 11 are actuated by the first electronic open-loop and closed-loop control unit A. Likewise, the two electric parking brakes 50a, 50b are actuated by the first electronic open-loop and closed-loop control unit A. This is indicated by the arrows with A.

The (second) pressure activation valve 10 and the separation valve 12 are actuated by the second electronic open-loop and closed-loop control unit B (this is indicated by the arrows with B).

The signals of the (first) motor angle sensor 43 are fed to the second electronic open-loop and closed-loop control unit B and evaluated by the latter, whereas the signals of the (second) motor angle sensor 42 are fed to the first electronic open-loop and closed-loop control unit A and evaluated by the latter.

The signals of the (first) pressure sensor 40 are, for example, supplied to the first electronic open-loop and closed-loop control unit A and evaluated by the latter.

Since the open-loop and closed-loop control unit A, on the basis of the signals from the pressure sensor 40, has information about the pressure generated by the pressure source 2, the second motor angle sensor 42, which is assigned to the open-loop and closed-loop control unit A, can optionally be dispensed with.

After one of the open-loop and closed-loop control units A or B fails, the pressure source 2 can still build up pressure by means of one of the motor windings 34a or 34b, albeit at a reduced level and with reduced dynamics. All four wheel brakes 5a-5d are subjected to said (central) pressure. The (central) pressure can also be modulated by pushing the piston 31 back and forth.

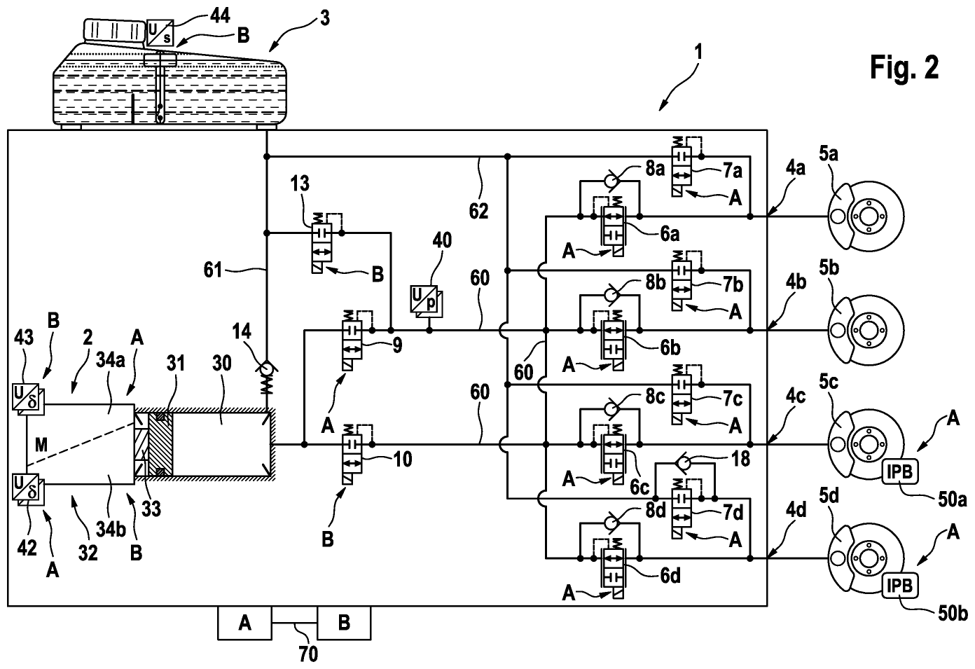

In the first exemplary embodiment the two separation valves 11, 12, only have the function of pressure equalization outside braking operations. According to the other exemplary embodiments (see FIGS. 2-5 and the description thereof), the pressure equalization function is also taken over by other valves.

FIG. 2 schematically illustrates a second exemplary embodiment of a brake controller 1 for a motor vehicle. The only differences over the first exemplary embodiment are a different separation valve device and an additional nonreturn valve 18. The two series-connected normally open separation valves 11, 12 are replaced by a single (first) separation valve 13, which is normally closed and is actuated by the second electronic open-loop and closed-loop control unit B. Furthermore, one of the outlet valves, for example the outlet valve 7d, is connected in parallel with a nonreturn valve 18 opening in the direction of the output port 4d.

The normally closed separation valve 13 is opened periodically or permanently outside braking operations. After a failure of the second open-loop and closed-loop control unit B, pressure equalization is ensured by at least one outlet valve 7a-7d being opened periodically or permanently outside braking operations. This function rotates across the outlet valves. In the de-energized state, a negative pressure in the system is avoided, since the nonreturn valve 18 is connected in parallel with respect to an outlet valve (7d). Positive pressure in the de-energized state due to thermal expansion of the brake fluid has to be accepted.

Also in the second exemplary embodiment instead of the two normally closed pressure activation valves 9, 10 which are connected in parallel, as an alternative (not illustrated), the pressure chamber 30 can be connected to the brake line section 60 via a (single) electrically actuable, normally open pressure activation valve with a nonreturn valve connected in parallel and opening in the direction of the inlet valves 6a-6d (correspondingly as shown in FIG. 6: first, normally open pressure activation valve 19 with a nonreturn valve 20 connected in parallel).

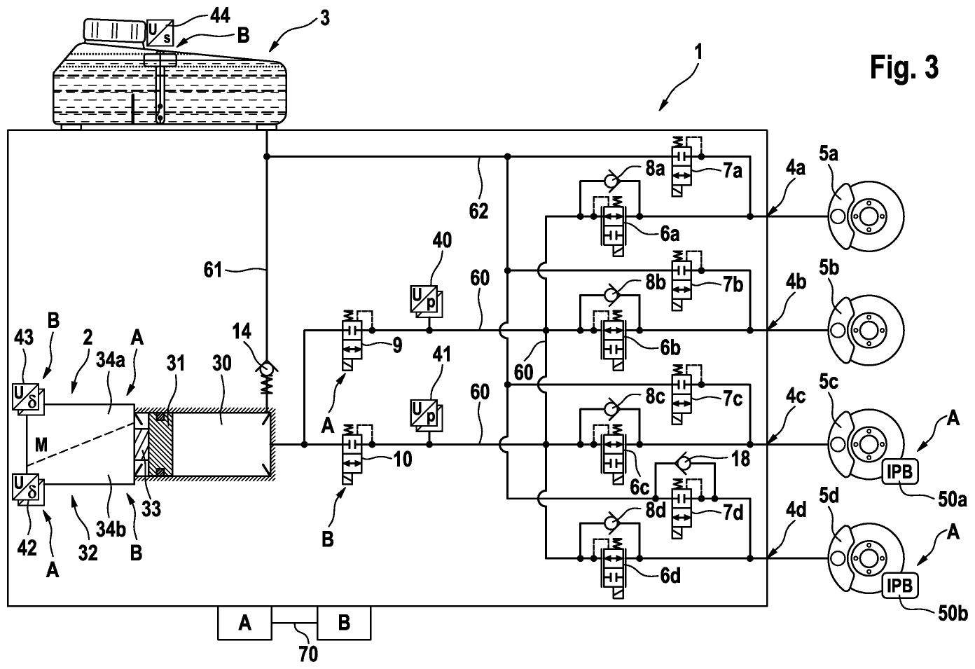

FIG. 3 schematically illustrates a third exemplary embodiment of a brake controller 1 for a motor vehicle. In contrast to the second exemplary embodiment, there is also no hydraulic connection from the brake line section 60 to the pressure medium reservoir 30 with the separation valve 13. In addition, the inlet and outlet valves of two wheel brakes, the inlet and outlet valves 6c, 6d, 7c, 7d, which are assigned to one of the axles (e.g. the rear axle (rear)), according to the third exemplary embodiment are actuated by the second electronic open-loop and closed-loop control unit B. In this exemplary embodiment, too, a nonreturn valve 18 opening in the direction of the ouput port 4d is connected in parallel with respect to one of the outlet valves, for example the outlet valve 7d. The inlet and outlet valves 6a, 6b, 7a, 7b of the other axle (for example, the front axle (front)) are actuated by the first electronic open-loop and closed-loop control unit A, as in the second exemplary embodiment.

For example, a second pressure sensor 41 which can be used to determine the pressure generated by the pressure source 2 is connected to the brake line section 60. The signals of the second pressure sensor 41 are fed to the other, i.e. the second electronic open-loop and closed-loop control unit B, and evaluated by the latter. The signals of one of the pressure sensors 40, 41 are thus available to each open-loop and closed-loop control unit A and B.

The pressure equalization function outside braking operations is taken over entirely by the outlet valves 7a-7d, analogously to the description of the second exemplary embodiment.

Since the wheel pressure modulation valves (i.e. inlet and outlet valves) are assigned to the open-loop and closed-loop control units A and B for each axle, pressure equalization is still guaranteed even after one of the open-loop and closed-loop control units A or B fails.

The pressure control functions (e.g. ABS (anti-lock control)) are distributed to both open-loop and closed-loop control units and are carried out jointly by both. Therein lies a certain disadvantage. On the other hand, if one of the open-loop and closed-loop control units A or B fails, wheel-specific pressure modulation in one axle is still possible. The two pressure sensors 40, 41 are also provided for this purpose, with each being assigned to one of the open-loop and closed-loop control units A or B.

Also in the third exemplary embodiment instead of the two normally closed pressure activation valves 9, 10 connected in parallel, as an alternative (not illustrated), the pressure chamber 30 can be connected to the brake line section 60 via a (first) electrically actuable, normally open pressure activation valve with a nonreturn valve connected in parallel and opening in the direction of the inlet valves 6a-6d (correspondingly as illustrated in FIG. 6).

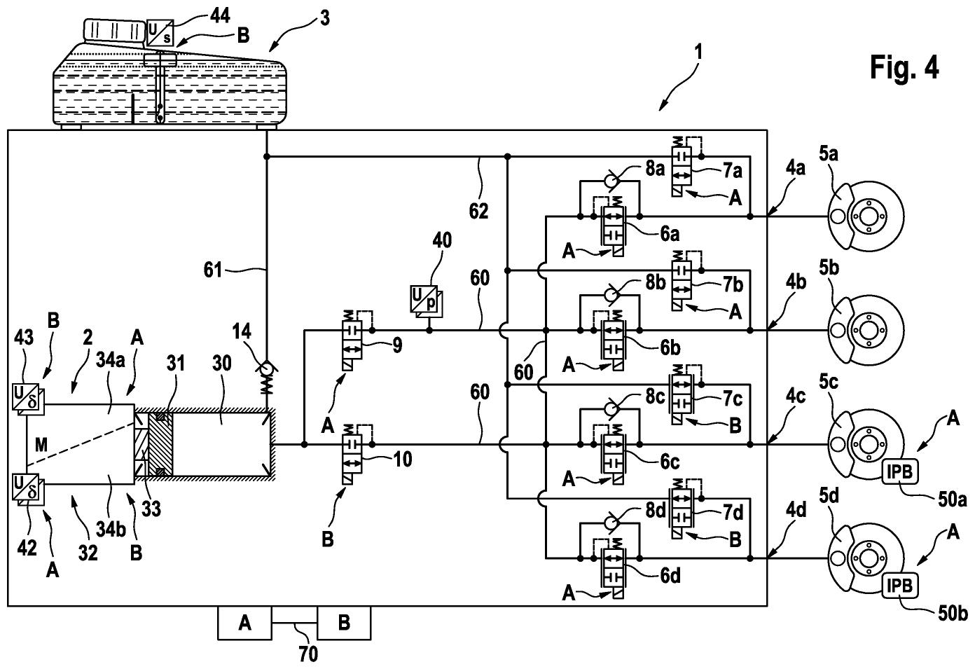

FIG. 4 schematically illustrates a fourth exemplary embodiment of a brake controller 1 for a motor vehicle. In contrast to the first exemplary embodiment, there is also no hydraulic connection from the brake line section 60 to the pressure medium reservoir 30 with the separation valves 11, 12. In addition, for example, the outlet valves 7c, 7d, which are assigned to the rear axle (rear), are activatable analogously and are normally open according to the third exemplary embodiment. Only the outlet valves 7c, 7d are actuated by the second electronic open-loop and closed-loop control unit B, while the remaining inlet and outlet valves 6a-6d, 7a, 7b are actuated by the first electronic open-loop and closed-loop control unit A. That is to say, the inlet and outlet valves 6a, 6b, 7a, 7b of the first output ports 4a, 4b and the inlet valves 6c, 6d of the second output ports 4c, 4d are actuated by the first electronic open-loop and closed-loop control unit A and the outlet valves 7c, 7d of the second output ports 4c, 4d are actuated by the second electronic open-loop and closed-loop control unit B.

After failure of the first electronic open-loop and closed-loop control unit A, all four wheels can be braked hydraulically by the second electronic open-loop and closed-loop control unit B closing the normally open outlet valves 7c, 7d. If suitable vehicle signals, in particular the wheel speeds, are available to the second open-loop and closed-loop control unit B, central pressure modulation for slip control is also possible.

After failure of the second open-loop and closed-loop control unit B, the inlet valves 6c, 6d of the rear axle (rear) are closed for each braking operation. The wheels of the front axle (front) are braked hydraulically (5a, 5b), the wheels of the rear axle (rear) are braked by the electric parking brakes 50a, 50b. Wheel-specific modulation continues to be possible.

In this exemplary embodiment both negative pressure and positive pressure are avoided in the de-energized state. The analogous function of the outlet valves 7c, 7d, which is much easier to implement on normally open valves than on normally closed valves, allows a selective comfort pressure reduction at the rear axle (“axle blending”) and also at each individual rear wheel. The valve power demand during a braking operation is increased, but this is likely to be more than compensated for by the lower power demand outside braking operations. The pressure control of each individual rear wheel is distributed to both open-loop and closed-loop control units A and B in this concept.

As illustrated schematically in FIG. 6, also in the fourth exemplary embodiment instead of the two normally closed pressure activation valves 9, 10 connected in parallel, the pressure chamber 30 can be connected to the brake line section 60 via a (single) electrically actuable, normally open pressure activation valve 19 with a nonreturn valve 20 connected in parallel and opening in the direction of the inlet valves 6a-6d. The pressure activation valve 19, like the pressure activation valve 9, is actuated by the first electronic open-loop and closed-loop control unit A.

As has already been mentioned above in connection with the first exemplary embodiment, the function of the pressure activation valves 9, 10 is to enable replenishment of the pressure source 2 after a volume-consuming pressure modulation. After failure of the first open-loop and closed-loop control unit A, however, no volume-consuming pressure modulation is in any case provided. Correspondingly, the two normally closed pressure activation valves 9, 10 which are connected in parallel and are actuated by different open-loop and closed-loop control units can be replaced by a single, normally open pressure activation valve 19 actuated by an open-loop and closed-loop control unit A.

The normally open valve 19 should have a flow resistance of a similarly small magnitude to that of a current normally closed pressure activation valve. However, a nonreturn valve 20 being connected in parallel with respect to the normally open pressure activation valve 19 in the pressure build-up direction alleviates this. A plurality of parallel nonreturn valves may be selected. A small flow resistance in the pressure build-up direction can thus be implemented. If the flow resistance in the pressure reduction direction is too great, rapid pressure reductions can be carried out via the (optionally analogous) outlet valves. The nonreturn valve 20 connected in parallel may also have increased robustness compared to a pressure activation valve that is closed due to an error.

In the sixth exemplary embodiment in FIG. 6 no valve has to be energized outside braking operations.

As also mentioned in the description of FIGS. 1 to 3 and 5, there are corresponding alternative exemplary embodiments, not illustrated, with a valve 19 (and optionally 20) to the first, second, third and fifth exemplary embodiments.

Regarding the alternative third exemplary embodiment (with a normally open pressure activation valve 19 combined with four normally closed outlet valves 7a-7d, which take over the pressure equalization (without a connection with the separation valve device to the pressure medium reservoir)), it should also be noted that, after failure of the open-loop and closed-loop control unit A, the wheel pressure modulation valves 6c, 6d, 7c, 7d (for example, of the rear axle (rear)) are still available, but the pressure source 2 can no longer be replenished. The appropriate slip control function at the rear axle is EBV (Electronic Brakeforce Distribution) with no volume consumption.

In the fourth exemplary embodiment as compared to the exemplary embodiments with four normally closed outlet valves 7a-7d can be seen in the fact that the two parking brakes 50a, 50b can no longer be distributed to both open-loop and closed-loop control units A and B without a loss of function, for example, in order to omit the transmission parking lock. If, in the fourth exemplary embodiment, as an alternative one of the two parking brakes, e.g. the parking brake 50b, has been activated by the second open-loop and closed-loop control unit B, following failure of the second open-loop and closed-loop control unit B only the front wheels (5a, 5b) and the one rear wheel (50a), the parking brake of which is assigned to the first open-loop and closed-loop control unit A, may be braked.

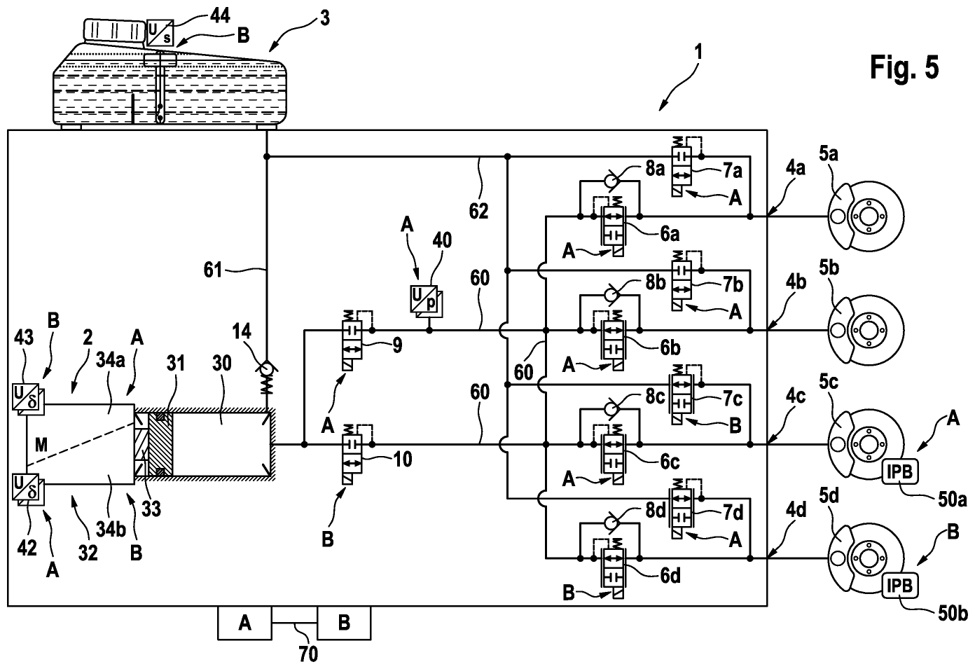

In the fifth exemplary embodiment of a brake controller 1 this is eliminated, as illustrated schematically in FIG. 5. As in the fourth exemplary embodiment, the outlet valves 7c, 7d, which are assigned to the rear axle (rear), are activatable analogously and are normally open. In contrast to the fourth exemplary embodiment, for one of the second output ports 4c, the inlet valve 6c is actuated by the first electronic open-loop and closed-loop control unit A and the associated outlet valve 7c is actuated by the second electronic open-loop and closed-loop control unit B, while the inlet valve 6d is actuated for the other second output port 4d by the second electronic open-loop and closed-loop control unit B and the associated outlet valve 7d is actuated by the first electronic open-loop and closed-loop control unit A. At the same time, the electrically actuable parking brake 50a assigned to the second output port 4c is actuated by the first electronic open-loop and closed-loop control unit A, while the other electrically actuable parking brake 50b assigned to the second output port 4d is actuated by the second electronic open-loop and closed-loop control unit B.

Following failure of one open-loop and closed-loop control unit A or B, both wheels on the front axle and one wheel on the rear axle can be braked hydraulically, and the other wheel on the rear axle is braked by the parking brake. For example, if the second open-loop and closed-loop control unit B fails, the wheel brakes 5a, 5b, 5d are braked hydraulically, and the parking brake 50a is braked; if the first open-loop and closed-loop control unit A fails, the wheel brakes 5a, 5b, 5c are braked hydraulically and the parking brake 50b is braked. Due to asymmetric modulation of the rear axle it might be difficult to achieve the same latency periods in the pressure modulation on both rear wheels.

Also in the fifth exemplary embodiment instead of the two normally closed pressure activation valves 9, 10 connected in parallel, as an alternative (not illustrated), the pressure chamber 30 can be connected to the brake line section 60 via a (first) electrically actuable, normally open pressure activation valve with a nonreturn valve connected in parallel and opening in the direction of the inlet valves 6a-6d (correspondingly as illustrated in FIG. 6).

In each of the exemplary embodiments, a second pressure sensor 41 is connected to the brake line section 60, with the signals of the second pressure sensor 41 being fed to the second electronic open-loop and closed-loop control unit B and evaluated by the latter (as described for the exemplary embodiment in FIG. 4).

The exemplary embodiments described thus far share the common feature that the pressure source 2 is a linear actuator with a double-wound electric motor 32, with each open-loop and closed-loop control unit A or B activating precisely one of the two motor windings 34a or 34b. For this purpose, the motor winding 34a is connected to the first open-loop and closed-loop control unit A and the other motor winding 34b is connected to the second open-loop and closed-loop control unit B. To activate the pressure source 2, each of the two open-loop and closed-loop control units A, B comprises a motor processor for processing the motor control functions, an output stage with transistors for providing the phase voltages at the electric motor 32 (e.g. B6 bridge) and a driver stage (gate drive unit) for activating the transistors of the output stage. The open-loop and closed-loop control unit A is supplied by a first electrical energy supply and the open-loop and closed-loop control unit B is supplied by a second electrical energy supply which is independent of the first energy supply.

According to an alternative, second exemplary embodiment, of the pressure source 2 and the activation thereof, which can be implemented in the brake controllers 1 of the exemplary embodiments in FIGS. 1 to 6, the pressure source 2 is formed by a cylinder-piston arrangement with a pressure chamber 30 and a piston 31, wherein the piston 31 can be pushed back and forth by an electromechanical actuator 32, 33, and wherein the electromechanical actuator comprises a single-wound electric motor 32 with only one motor winding. To activate the pressure source 2, each of the open-loop and closed-loop control units A, B comprises a motor processor for processing the motor control functions, an output stage with transistors for providing the phase voltages at the electric motor 32 (e.g. B6 bridge) and a driver stage (gate drive unit) for activating the transistors of the output stage. In this way, each of the open-loop and closed-loop control units A, B can provide the phase voltages required for the operation of the electric motor 32. Both output stages (or both open-loop and closed-loop control units A, B) are connected to the motor winding of a single-wound electric motor 32. The output stages are designed in such a way that their outputs are high-impedance in the passive state or if the associated open-loop and closed-loop control unit A or B fails. Thus, the motor winding of the electric motor 32 can be activated by any open-loop and closed-loop control unit A or B, and, in the event of said unit failing, the other open-loop and closed-loop control unit B or A can take over this task. A motor processor, driver stage and output stage are therefore implemented redundantly and the electric motor 32 has a single winding. The open-loop and closed-loop control unit A is supplied by a first electrical energy supply and the open-loop and closed-loop control unit B is supplied by a second electrical energy supply which is independent of the first energy supply.

According to an alternative, third exemplary embodiment, of the pressure source 2 and the activation thereof, which can be implemented in the brake controllers 1 of the exemplary embodiments in FIGS. 1 to 6, the pressure source 2 is formed by a cylinder-piston arrangement with a pressure chamber 30 and a piston 31, wherein the piston 31 can be pushed back and forth by an electromechanical actuator 32, 33, and wherein the electromechanical actuator comprises a single-wound electric motor 32 with only one motor winding. In addition to the first electronic open-loop and closed-loop control unit A and the second electronic open-loop and closed-loop control unit B, there is a third electronic open-loop and closed-loop control unit. To activate the pressure source 2, each of the open-loop and closed-loop control units A, B comprises a motor processor for processing the motor control functions. The third open-loop and closed-loop control unit has redundant (i.e. at least two) output stages with transistors for providing the phase voltages on the electric motor 32 (e.g. B6 bridge) and redundant (i.e. at least two) driver stages (gate drive units) for activating the transistors of the output stage. The third open-loop and closed-loop control unit also comprises a plurality of relays, which allow each motor processor to be able to transmit its output signals to each of the two driver stages and each driver stage to be able to activate each output stage. The outputs of both output stages are connected to the winding of a single-wound motor. The driver stage and output stage are therefore implemented redundantly on a third open-loop and closed-loop control unit, and the electric motor 32 has a single winding.

In the third exemplary embodiment of the pressure source 2 and the activation thereof, the first open-loop and closed-loop control unit A is supplied by a first electrical energy supply and the second open-loop and closed-loop control unit B is supplied by a second electrical energy supply which is independent of the first energy supply (so-called redundant vehicle electrical system). In addition, the third open-loop and closed-loop control unit is connected to the two independent energy supplies (voltage sources) of the redundant vehicle electrical system. Additional relays can be used to ensure the energy supply (voltage supply) of the third open-loop and closed-loop control unit or of the driver stage and output stage even if one of the energy supplies (voltage sources) fails, by switching to the other energy supply (voltage source).

The third exemplary embodiment of the pressure source 2 and the activation thereof enables the electric motor 32 to be activated in the event of more electronic double faults than the second exemplary embodiment of the pressure source 2 and the activation thereof. Such double faults include, for example, the simultaneous failure of a driver stage and any output stage, or the simultaneous failure of a motor processor and any driver stage, or the simultaneous failure of an output stage and any voltage source.

According to an alternative, fourth exemplary embodiment, of the pressure source 2 and the activation thereof, which can be implemented in the brake controllers 1 of the exemplary embodiments in FIGS. 1 to 6, the pressure source 2 is formed by a cylinder-piston arrangement with a pressure chamber 30 and a piston 31, wherein the piston 31 can be pushed back and forth by an electromechanical actuator 32, 33 comprising two (e.g. single-wound) electric motors 32. For example, each of the two electric motors controls one of two ball screw drives. The ball screw drives act on the two ends of a balance beam, the center of which is mechanically connected to the piston 31. In error-free operation, the ball screw drives are moved in and out in parallel in order to move the piston 31 and build up or reduce pressure in the wheel brakes. If an electric motor fails, the remaining functional electric motor can still move one end of the balance beam and thus move the piston 31 back and forth. In this case, the force that can be exerted on the piston 31 is less and the range of motion available may be reduced. To activate the pressure source 2, each of the open-loop and closed-loop control units A, B comprises a motor processor for processing the motor control functions, an output stage with transistors for providing the phase voltages at the electric motor 32 (e.g. B6 bridge) and a driver stage (gate drive unit) for activating the transistors of the output stage. The output stage of the first open-loop and closed-loop control unit A is connected to one electric motor, the output stage of the second open-loop and closed-loop control unit B is connected to the other electric motor. That is to say, the first open-loop and closed-loop control unit A activates the first electric motor 32 and the second open-loop and closed-loop control unit B activates the second electric motor 32. The open-loop and closed-loop control unit A is supplied by a first electrical energy supply and the open-loop and closed-loop control unit B is supplied by a second electrical energy supply which is independent of the first energy supply.

The electrohydraulic brake controller 1 is used in a brake system with an actuation unit for a vehicle driver and at least two electrically actuable parking brakes 50a, 50b. The parking brakes are arranged on an axle of the vehicle, e.g. the rear axle. In this case, the actuation unit is connected to the brake controller 1 on the signal side in order to transmit a driver's request signal, but there is no mechanical-hydraulic connection from the actuation unit to the brake controller 1.

Various variants of a brake controller 1 are proposed which, as a central unit, generates and modulates the pressure for four hydraulic wheel brakes 5a-5d and is suitable for use in a brake system without a mechanical-hydraulic driver fall-back level. The brake system essentially consists of a central, electrohydraulic brake controller 1 and an actuation unit for the driver, which is connected to the central brake controller 1 only through the fail-safe transmission of a driver's request signal. In addition, electric parking brakes which are also activated by the central brake controller 1 are provided on one axle (typically the rear axle).

All the exemplary embodiments are characterized by the requirement that it should be possible to brake all four wheels after each single electrical or electronic fault. On the other hand, after a mechanical fault, such as a leak, it should be permissible to decelerate the vehicle only via the dynamic braking function of the electric parking brakes 50a, 50b, optionally with assistance of an electric drive train. A position of the vehicle's center of gravity suitable for this purpose is usually provided in vehicles nowadays and is required. This requirement is based on the experience that mechanical faults occur substantially less frequently than electronic faults.

All of the proposed hydraulic brake controllers 1 meet the basic requirement of four-wheel braking after an electrical fault in that, inter alia, they are activated by two separate open-loop and closed-loop control units A and B, which are connected via redundant signal lines 70. Furthermore, electrical and/or electronic means are provided which are configured such that, if the first electronic open-loop and closed-loop control unit A fails, the electromechanical actuator is activated by the second electronic open-loop and closed-loop control unit B and builds up pressure to actuate the wheel brakes 5a-5b, and that, if the second electronic open-loop and closed-loop control unit B fails, the electromechanical actuator 32 is activated by the first electronic open-loop and closed-loop control unit A and builds up pressure to actuate the wheel brakes 5a-5b. The electrical and/or electronic means are therefore designed in such a way that if one (or each) of the two open-loop and closed-loop control units A or B fails, the remaining functional open-loop and closed-loop control units B or A can activate the electromechanical actuator of the (single) pressure source 2 at least with part of its power to build up pressure to actuate the wheel brakes in a brake-by-wire operating mode for service braking.

In addition, the brake controller 1 contains valves and sensors, each of which is assigned to precisely one open-loop and closed-loop control unit A or B.

The redundant signal lines 70 between the open-loop and closed-loop control units A and B prevent the open-loop and closed-loop control units from erroneously detecting a failure or fault-free functioning of the other open-loop and closed-loop control unit in the event of a fault in one of the signal lines.

The brake controller 1 is supplied by a redundant vehicle electrical system with two independent voltage sources (first electrical energy supply and second electrical energy supply), such that the two open-loop and closed-loop control units A and B are not supplied by the same voltage source. For example, open-loop and closed-loop control units A are supplied by the first electrical energy supply and open-loop and closed-loop control units B are supplied by the second electrical energy supply.

1. An electrohydraulic brake controller for a motor vehicle, comprising:
at least two first output ports and two second output ports for at least four hydraulically actuable wheel brakes,
a first electronic open-loop and closed-loop control unit,
a second electronic open-loop and closed-loop control unit,
a pressure medium reservoir under atmospheric pressure,
an inlet valve for each first and second output port,
an outlet valve for each first and second output port, via which the respective output port is connected to the pressure medium reservoir,
a pressure source formed by a cylinder-piston arrangement with a pressure chamber and a piston which is moveable by an electromechanical actuator,
a brake line section to which the at least four inlet valves are connected, wherein the pressure chamber is connected via a first electrically actuable pressure activation valve to the brake line section, and
wherein when the first electronic open-loop and closed-loop control unit fails, the electromechanical actuator is activated by the second electronic open-loop and closed-loop control unit and builds up pressure to actuate the wheel brakes, and when the second electronic open-loop and closed-loop control unit fails, the electromechanical actuator is activated by the first electronic open-loop and closed-loop control unit and builds up pressure to actuate the wheel brakes.

2. The electrohydraulic brake controller as claimed in claim 1, wherein the electromechanical actuator comprises a double-wound electric motor with a first motor winding and a second motor winding, the first motor winding being activated by the first electronic open-loop and closed-loop control unit and the second motor winding being activated by the second electronic open-loop and closed-loop control unit.

3. The electrohydraulic brake controller as claimed in claim 1, wherein the first pressure activation valve and at least the inlet and outlet valves of the first output ports are actuated by the first electronic open-loop and closed-loop control unit.

4. The electrohydraulic brake controller as claimed in claim 1, wherein the first electrically actuable pressure activation valve is normally closed and the pressure chamber is connected via a second electrically actuable pressure activation valve, which is normally closed, to the brake line section which is actuated by the second electronic open-loop and closed-loop control unit.

5. The electrohydraulic brake controller as claimed in claim 1, wherein the first electrically actuable pressure activation valve is normally open.

6. The electrohydraulic brake controller as claimed in claim 1, wherein no valve is arranged in the brake line section between the first electrically actuable pressure activation valve and each of the inlet valves.

7. The electrohydraulic brake controller as claimed in claim 1, wherein the inlet and outlet valves of the second output ports are actuated by the first electronic open-loop and closed-loop control unit, and the brake line section is connected to the pressure medium reservoir via a separation valve device having at least one first electrically actuable separation valve, the first separation valve being actuated by the second electronic open-loop and closed-loop control unit.

8. The electrohydraulic brake controller as claimed in claim 7, wherein the first separation valve is normally closed and the separation valve device comprises only the first electrically actuable separation valve.

9. The electrohydraulic brake controller as claimed in claim 1, wherein the inlet and outlet valves of the second output ports are actuated by the second electronic open-loop and closed-loop control unit.

10. The electrohydraulic brake controller as claimed in claim 8, wherein a nonreturn valve opening in the direction of the output port is connected in parallel with respect to one of the outlet valves.

11. The electrohydraulic brake controller as claimed in claim 1, wherein each of the inlet valves is activatable analogously and is normally open, and each of the outlet valves is normally closed.

12. The electrohydraulic brake controller as claimed in claim 1, wherein the outlet valves of the second output ports are normally open.

13. The electrohydraulic brake controller as claimed in claim 12, wherein the inlet valves of the second output ports are actuated by the first electronic open-loop and closed-loop control unit, and the outlet valves of the second output ports are actuated by the second electronic open-loop and closed-loop control unit.

14. The electrohydraulic brake controller as claimed in claim 1, wherein electrically actuable parking brakes are provided on the wheels assigned to the wheel brakes of the second output ports, the electrically actuable parking brakes being actuated by the first electronic open-loop and closed-loop control unit.

15. The electrohydraulic brake controller as claimed in claim 12, wherein for the one second output port the inlet valve is actuated by the first electronic open-loop and closed-loop control unit and the outlet valve is actuated by the second electronic open-loop and closed-loop control unit, and for the other second output port, the inlet valve is actuated by the second electronic open-loop and closed-loop control unit and the outlet valve is actuated by the first electronic open-loop and closed-loop control unit.

16. The electrohydraulic brake controller as claimed in claim 15, wherein a first electrically actuable parking brake, which is actuated by the first electronic open-loop and closed-loop control unit, is provided on the wheel which is assigned to the one second output port, and in that a second electrically actuable parking brake, which is actuated by the second electronic open-loop and closed-loop control unit, is provided on the wheel which is assigned to the other second output port.

17. A brake system comprising:
an actuation unit for a vehicle driver,
an electrohydraulic brake controller,
at least two first output ports and two second output ports for at least four hydraulically actuable wheel brakes,
a first electronic open-loop and closed-loop control unit,
a second electronic open-loop and closed-loop control unit,
an inlet valve for each first and second output port,
an outlet valve for each first and second output port, via which the respective output port is connected to a pressure medium reservoir,
wherein a pressure source is formed by a cylinder-piston arrangement with a pressure chamber and a piston, wherein the piston can be pushed back and forth by an electromechanical actuator,
a brake line section to which the at least four inlet valves are connected, wherein the pressure chamber is connected via a first electrically actuable pressure activation valve to the brake line section, and
wherein the electromechanical actuator is activated by the second electronic open-loop and closed-loop control unit and builds up pressure to actuate the wheel brakes when the first electronic open-loop and closed-loop control unit fails, and the electromechanical actuator is activated by the first electronic open-loop and closed-loop control unit and builds up pressure to actuate the wheel brakes when the second electronic open-loop and closed-loop control unit fails; and
wherein the actuation unit is connected to the brake controller by transmitting a driver's request signal and there is no mechanical-hydraulic connection from the actuation unit to the brake controller.
